(19) United States
(12) Patent Application Publication
(10) Pub. No.: US 2020/0103268 A1
(43) Pub. Date: Apr. 2, 2020

(54) Fill level gauge with a continuously measuring fill level sensor and method for operating such a fill level gauge

(71) Applicant: VEGA GRIESHABER KG, Wolfach (DE)

(72) Inventors: Karl Grießbaum, Mühlenbach (DE); Jürgen Motzer, Gengenbach (DE); Jürgen Skowaisa, Schiltach (DE); Jürgen Haas, Oberwolfach (DE)

(21) Appl. No.: 16/552,796

(22) Filed: Aug. 27, 2019

(30) Foreign Application Priority Data
Sep. 28, 2018 (EP) 18 197 579.8

(51) Int. Cl. G01F 23/284

(52) U.S. Cl. CPC G01F 23/284

(57) ABSTRACT

Fill level gauge with a single continuously measuring fill level sensor and at least one processor for controlling the fill level sensor and for evaluating the measurements, with the fill level gauge having at least a first operating mode and a second operating mode for determining the fill level, with the measuring device showing in the first operating mode a first measurement rate and a first measurement precision and in the second operating mode showing a second measurement rate and a second measurement precision, wherein the first measurement rate is lower than the second measurement rate and/or the first measurement accuracy is lower than the second measurement accuracy.

### STATEMENT REGARDING FEDERALLY SPONSORED RESEARCH OR DEVELOPMENT

No federal government funds were used in researching or developing this invention.

### CROSS REFERENCE TO RELATED APPLICATIONS

This patent application claims priority to European Patent Application 18197579.8, filed on Sep. 28, 2018.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is a fill level gauge with a continuously measuring fill level sensor and a method for operating such a fill level gauge.

### BACKGROUND OF THE INVENTION

The present invention relates to a fill level gauge with a continuously measuring fill level sensor according to the preamble of claim 1 and a method for operating such a fill level gauge according to the preamble of claim 11.

Fill level gauges with continuously measuring fill level sensors are generally known from the prior art.

The level gauges underlying here are used for continuous fill level measurement. In the process, the filling height of a medium is recorded in a tank, basin or silo using different measurement methods and converted into an electronic signal. Continuously measuring fill level sensors are characterized by the fact that fill levels are not only recorded on discrete, predefined fill levels, so-called limit levels, but rather a continuous measurement of filling levels is possible, i.e., in particular any filling levels. Typical measurement methods are runtime-based procedures such as radar or ultrasound, hydrostatic methods such as pressure measurement, or capacitive or radiometric methods.

Fill level measuring devices with continuously measuring fill level sensors are already used in prior art in combination with limit switches for monitoring rain overflow pools.

A rain overflow pool is a specific form of a relief structure for mixing systems with upstream storage reservoir consisting of drain to the water treatment facility and overflow to a water body. In mixing systems, rain and waste water is fed together to a channel and thus to the water treatment plant. In order to relieve the mixing water drainage and the sewage treatment system in the event of heavy rain events, retaining facilities and relief facilities must be provided for this system. After the end of the rain the contents of the reservoirs are drained to the wastewater treatment plant and cleaned there. Only the portion that exceeds the retention volume of the reservoirs is introduced as heavily diluted mixed water via the rain overflow into a water body.

In order to monitor the operating behavior of rain overflow pools in rain, many pools are equipped with measuring devices. These monitoring devices log the frequency and duration of congestion and relief events. Some also determine the mixed water volume overflown in severe rain events, i.e., the water volume that could not be absorbed by the rain retention pool and therefore had to be released into a water body.

Rain overflow pools are often outside of residential areas and therefore do not have any connection to an energy supply network. Network-linked measuring technology can thus be used only with high investment costs for a network connection and is therefore often undesired. Thus, battery operated and/or solar-powered measuring devices are often used. The energy consumption of these measuring instruments is therefore an important criterion for any decision.

A schematic representation of a rain overflow basin 100 with a measuring arrangement according to the prior art is shown in FIG. 1.

For monitoring a fill level of the rain overflow basin 100, several sensors 101, 102 are used in prior art. On the one hand, a continuously measuring fill level sensor 101 and a limit sensor 102. Depending on a cover state of the limit sensor 102 (covered/uncovered), the continuously measuring sensor 101 is activated via a switching unit 104. This then reports the fill level to a control unit or the like.

The background for this structure is that in the normal case the rain overflow basin 100 is empty or only partially filled and quickly fills up only in the case of rain or storm events, and thus, in order to save energy, only when a certain limit level is exceeded, which is monitored with the limit sensor 102, (the activation of) the limit fill sensor 101 is necessary.

In the systems known from the prior art, the use of two different sensor types is perceived as disadvantageous, as this leads to an increased maintenance and installation effort. In addition, the energy consumption of limit sensors, e.g., vibration limit sensors, is relatively high, so that they are not optimal with battery-operated measuring arrangements.

The objective of the present invention is to provide a fill level gauge and a method for operating a fill level gauge that does not have the disadvantages of the prior art.

This objective is attained with a fill level gauge having the characteristics described herein.

### BRIEF SUMMARY OF THE INVENTION

In a preferred embodiment, a fill level gauge with a single continuously measured fill level sensor (200) and at least one processor (500) for controlling the fill level sensor (200) and for evaluating the measurements, characterized in that the fill level gauge has at least a first operating mode (300) and a second operating mode (301) for determining the fill level, with the measuring device showing in the first operating mode (300) a first measuring rate and a first measuring precision and showing in the second operating mode (301) a second measuring rate and a second measuring accuracy, wherein the first measurement rate is lower than the second measurement rate and/or the first measurement accuracy is lower than the second measurement accuracy.

In another preferred embodiment, a fill level gauge as described herein, characterized in that the measuring device has a first processor (500) and a second processor (501), wherein the first processor (500) has a lower energy consumption than the second processor (501) and in the first operating mode (300) the first processor (500) is activated and in the second operating mode (301) at least the second processor (501) is activated.

In another preferred embodiment, a fill level gauge as described herein, characterized in that the second processor (501) is deactivated in the first operating mode (300).

In another preferred embodiment, a fill level gauge as described herein, characterized in that the second processor (501) can be activated by the first processor (500).

In another preferred embodiment, a fill level gauge as described herein, characterized in that the fill level gauge has a processor (500, 501) with at least two operating states (300, 301), with the processor (500, 501) in the first operating state (300) showing a lower energy consumption than in the second operating state (301), and the processor (500, 501) in the first operating mode (300) being in the first operating state and in the second operating mode (301) it is in the second operating state.

Fill level gauge according to any of the preceding claims, characterized in that a change from the first operating mode (300) into the second operating mode (301) occurs when a predetermined first fill level (103) is fallen short and/or a predetermined second fill level (103) is exceeded and a change occurs from the second operating mode (301) into the first operating mode (300) when the predetermined first fill level (103) is exceeded and/or the predetermined second fill level (103) is fallen short.

In another preferred embodiment, a fill level gauge as described herein, characterized in that the change takes place in consideration of a hysteresis.

In another preferred embodiment, a fill level gauge as described herein, characterized in that a fill level measurement in the first operating mode (300) is carried out cyclically, especially in 1 to 5 minute increments.

In another preferred embodiment, a fill level gauge as described herein, characterized in that the fill level gauge is designed as a radar fill level gauge.

In another preferred embodiment, a fill level gauge as described herein, characterized in that the fill level gauge is designed as a single-use device with a battery installed in particular fixed in the device.

In an alternate preferred embodiment, a method for operating a fill level gauge with a single continuously measured fill level sensor (200) and at least one processor (500, 501) for controlling the fill level sensor (200) and for evaluating the measurements, characterized in that the fill level gauge comprises at least a first operating mode (300) and a second operating mode (301) for determining the fill level, with the measuring device in the first operating mode (300) operating with a first measuring rate and a first measuring accuracy and in the second operating mode (301) with a second measuring rate and a second measuring accuracy, wherein the first measurement rate is lower than the second measurement rate and/or the first measurement accuracy is lower than the second measurement accuracy.

In another preferred embodiment, the method as described herein, characterized in that the fill level gauge has at least one first processor (500) and a second processor (501), wherein the first processor (500) shows lower energy consumption than the second processor (501), and in the first operating mode (300) the first processor (500) is activated and in the second operating mode (301) at least the second processor (501) is activated.

In another preferred embodiment, the method as described herein, characterized in that the second operating mode (301) is activated when a first defined fill level (103) is fallen short and/or when a second defined fill level (103) is exceeded.

In another preferred embodiment, the method as described herein, characterized in that the first operating mode (300) is activated when the first fill level is exceeded and/or when the second fill level is fallen short.

In another preferred embodiment, the method as described herein, characterized in that the first operating mode (300) is activated with a hysteresis when the first fill level is exceeded and/or when the second fill level is fallen short.

In another preferred embodiment, the method as described herein, characterized in that the fill level gauge is deactivated in the first operating mode (300) after each measurement for a predetermined period of time or switched into a sleep mode.

### BRIEF DESCRIPTION OF THE DRAWINGS

FIG. 1 is a line drawing evidencing a schematic representation of a rain overflow basin with a measuring arrangement according to the prior art (already discussed).

FIG. 2 is a line drawing evidencing the rain overflow basin from FIG. 1 with a measuring arrangement according to the present application.

FIG. 3 is a line drawing evidencing measurement cycles in the different operating modes.

FIG. 4 is a line drawing evidencing the measurement uncertainty in the different operating modes.

FIG. 5 is a line drawing evidencing an embodiment with two processors.

FIG. 6 is a line drawing evidencing an alternative embodiment with two processors.

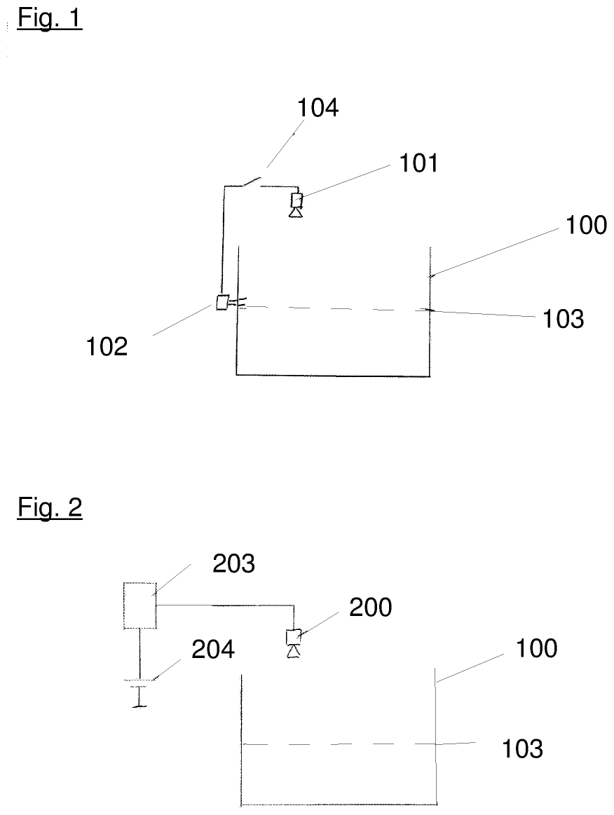

### DETAILED DESCRIPTION OF THE INVENTION

A fill level gauge according to the invention with a single continuously measuring fill level sensor and at least one processor to control the fill level sensor and to evaluate the measurement results is characterized by the fact that the fill level gauge has at least a first operating mode and a second operating mode for determining the fill level, with the measuring device in the first operating mode showing a first measuring rate and/or a first measurement accuracy and in the second operating mode showing a second measuring rate and a second measuring accuracy, with the first measuring rate being lower than the second measuring rate and/or the first measuring accuracy being lower than the second measurement accuracy.

The fill level gauge according to the invention thus comprises only a single continuously measuring fill level sensor for monitoring the height or fill level, and does not need a second sensor, particularly a limit sensor, as do the measurement arrangements of the prior art. This way, the initial investment is reduced and the maintenance effort is lower when operating the fill level gauge. Due to the fact that only a single sensor is used, it is easier to design it independent of any external power supply, e.g., battery powered.

Alternatively, embodiments with an energy harvester and a battery buffer are conceivable.

By the embodiment of the fill level gauge with a first operating mode and a second operating mode, wherein the measuring instrument has a first measurement rate and a first measuring accuracy in the first operating mode, and has a second measurement rate and a second measurement accuracy in the second operating mode, here an arrangement is created which has reduced energy consumption in the first operating mode due to the lower measurement rate and/or measurement accuracy. In case of an application scenario, as described in the rain overflow pool, in which a fill level is given over a large amount of time, e.g., at least 95%, preferably 99% of the time such that the lower measuring rate and/or measuring accuracy is sufficient, then a very energy-efficient operation of the fill level gauge is possible. In this way, a power grid-independent, particularly battery-operated use of the fill level gauge is promoted.

Additional types of use could be mobile applications, for example, if a container is emptied or filled over an extended period of time, and the higher measurement rate and/or measurement accuracy, i.e., the second operating mode, is only required within the last 10% of the emptying and/or filling process. The threshold depends largely on the respective application; here depending on the filling or emptying speed, the threshold can be higher or lower. For example, the coasting of a pump can be ignored when determining the threshold.

In this scenario as well a battery operation can also be facilitated.

It is noted at this point that the lower measurement rate and/or measurement accuracy in the first operating mode explicitly indicates that measurements take place in the first operating mode. The lower measurement rate and/or measuring accuracy therefore do not explicitly mean that no measurements take place in the first operating mode.

For example, the first measurement rate can be 10% or less of the second measurement rate.

For example, in the first operating mode, a measurement can be carried out once per hour and measured in the second operating mode, e.g., twice per second.

Typically, the measurement rate in the first operating mode can range from 0.01 measurements per minute to 1 measurement per minute, for example be 1/60 measurements per minute or 0.1 measurements per minute. In the second operating mode, the measurement rate can preferably exceed 1 measurement per second.

Ideally, the first measurement rate can be predefined in the first operating mode and the second measurement rate in the second operating mode.

For example, the fill level gauge can have a first processor and a second processor, wherein the first processor has a lower energy consumption than the second processor and in the first operating mode the first processor is activated and in the second operating mode the second processor is activated.

Through an embodiment of the fill level gauge with two different processors, for example a first processor with a power of less than 1 mW and a second processor with a power of more than 30 mW, the first processor may be activated in the first operating mode and the second processor in the second operating mode. Since in the first operating mode a lower measurement rate and/or measuring accuracy is necessary, the first processor can be selected with a lower computing power and thus simultaneously be more energy saving. If a specified fill level is exceeded or fallen short, then the second processor is activated and the measurement rate and/or measurement accuracy is increased accordingly. The second processor can be selected with a computing capacity of 20 MHz and more, which is usual from the prior art, and a corresponding energy consumption of 30 mW or more.

To optimize the energy requirement of the fill level gauge in the first operating mode, the second processor can be deactivated in the first operating mode. A complete deactivation of the second processor in the first operating mode has the advantage that any standby energy can be waived which the second processor would require in an energy saving mode. The second processor can, for example, be completely separated from a power supply, e.g., via a switch element.

If the second processor detects the overrun or shortfall of the specified fill level, then the second processor can be activated by the first processor for the transition from the first operating mode to the second operating mode. In addition, the first processor can be activated by the second processor in a manner such that when a transition occurs from the second operating mode into the first operating mode the first processor is activated and the second processor is deactivated as soon as the first processor is activated.

Through such an embodiment, a simultaneous operation of both processors is avoided and thus energy is saved.

Alternatively, the first processor can monitor the measurement rate and, depending on the operating mode, activate the second processor more often or less often for a measurement. The measurements are always carried out in this variant by the second processor, whereby the measurement rate is specified by the first processor, and between the measurements the second processor is switched to a rest state or deactivated, in particular in the first operating mode.

Alternatively, the fill level gauge may have a single processor with at least two operating states, wherein the processor has lower energy consumption in the first operating state than in the second operating state and the processor is in the first operating mode in the first operating state and in the second operating mode in the second operating state.

Through such a processor with different operating states, an energy-saving effect can also be achieved, whereby the first operating state of the processor corresponds to an energy saving state with reduced computing performance. The second operating state corresponds to a regular operation of the processor, whereby the full computing power is available.

In an advantageous embodiment, a change from the first operating mode can be carried out into the second operating mode upon falling below a specified first fill level and/or when a specified second fill level is exceeded, and a change from the second operating mode is carried out into the first operating mode in the event of exceeding the specified first fill level and/or if the specified second fill level is fallen short.

In this way, the higher measurement rate and/or measurement accuracy is only activated in the situations in which overfilling is looming or the monitored container may run empty. Otherwise, energy is saved in the first operating mode by the lower measurement rate and/or measurement accuracy.

In order to avoid frequent switching between the two operating modes, it is beneficial for the change to take place in consideration of a hysteresis.

In the first operating mode, a fill level measurement can be carried out cyclically, especially in 1 to 5 minute increments. The measurement rate, i.e., how often measurements are taken per unit of time, can be preset or determined on the basis of the most recently measured fill level. For example, it can be achieved that even in the energy saving mode, more frequent measurements occur if the measured fill level is approaching one of the predetermined limit levels. In addition, or alternatively, the minimum measurement rate can be specified in such a way that, starting from the last determined fill level, even at maximum permissible filling or emptying speed, another measurement is carried out even before the predetermined limit levels are reached. In this way, it can be prevented that in the first operating mode of the monitored containers, however, empty-o is empty without this being documented or prevented.

In a preferred embodiment form, the fill level gauge is designed as a radar fill level gauge. Radar fill level gauges are easy to install and show a high measurement accuracy. Radar sensors can also be operated very energy efficiently.

The fill level gauge can be designed for example as a single-use device with a battery installed in particularly fixed in the device. For example, it is conceivable to equip a fill level gauge with a permanently installed, in particular soldered and welded energy source, e.g., a lithium ion battery, similar to those for smoke alarm devices of prior art. Sensors with a permanently installed battery can also be installed permanently in a container that is transportable for example, e.g., glued to it.

In addition, it can be useful if the fill level gauge has an energy-saving radio module, e.g,. a mobile phone module, a Bluetooth low energy module, or an energy-saving Wifi module to transmit the data determined to a superordinate unit, e.g., a control room.

In addition, the fill level gauge may have a data logger, i.e., a memory in which several measured values can be saved temporarily, e.g., if there is no connection to the superordinate unit, or if such a connection is only to be made in rare occasions for energy saving reasons.

A method according to the invention for operating a fill level gauge with a single continuously measuring fill level sensor and at least one processor to control the filling level sensor and to evaluate the measurements is characterized by a fill level gauge comprising at least a first operating mode and a second operating mode for determining the fill level, with the measuring device in the first operating mode being operated with a first measuring rate and a first measuring accuracy and in the second operating mode operated with a second measuring rate and a second measuring accuracy, whereby the first measurement rate is lower than the second measurement rate and/or the first measurement accuracy is lower than the second measurement accuracy.

In the event that the fill level gauge is operated in the first operating mode with a lower measurement rate and/or a lower measurement accuracy than in the second operating mode, the energy consumption of the fill level gauge decreases significantly, so that a battery-powered device can be used significantly longer.

In a further development, the fill level gauge may have at least one first processor and a second processor, wherein the first processor has a lower energy consumption than the second processor, whereby the first processor is activated in the first operating mode and in the second operating mode at least the second processor is activated.

Due to the fact that in the first operating mode only the first processor is activated, which has a lower energy consumption, energy can be saved significantly in the first operating mode compared to the second operating mode. Typically, the first processor is then less efficient than the second processor due to a lower processor cycle, so that it is operated with a lower measurement rate and/or a lower measurement accuracy when taking measurements.

The second operating mode can be activated, for example, when a first specified fill level is fallen short and/or when a second specified fill level is exceeded, so that, for example, a draining empty and/or overrun of the monitored container can be prevented or detected. However, other specified fill levels can be monitored as well, e.g., a fill level window from exceeding a first defined fill level to exceeding a second specified fill level.

To avoid excessively frequent switching from the first operating mode into the second one and vice versa in case of fill level fluctuations near the predetermined fill level, it can be provided that the first operating mode is activated and/or deactivated with a hysteresis when the first fill level is fallen short and/or when the second fill level is exceeded.

In order to save more energy, the fill level gauge can be deactivated in the first operating mode after a measurement was taken for a predetermined period of time or set into a sleep mode. In this way, only a reduced energy requirement is necessary for operating a wake-up circuit, so that the energy consumption of the fill level gauge is further reduced.

### DETAILED DESCRIPTION OF THE FIGURES

FIG. 2 shows the monitoring of a rain overflow basin 100 with a single continuously measuring fill level sensor 200. The continuously measuring fill level sensor 200 is positioned above the rain overflow basin 100 such that an emitted measuring signal, in the present case a radar signal, reaches a surface of a medium present in the rain overflow basin 100 unimpeded, and thus a runtime measurement and therefrom a level measurement is possible. Due to the fact that only a single continuously measuring level sensor 200 is used, here considerable acquisition and installation costs can be saved and the maintenance effort is reduced for operating the rain overflow basin 100. The fill level sensor 200 shown in the present case is supplied with energy via a battery 204.

The measurements yielded by the continuously measuring fill level sensor 200 are transmitted via a radio interface, not explicitly shown, in a measuring electronics unit 203 to a superordinate unit, e.g., a control unit, where the measured values are saved and evaluated.

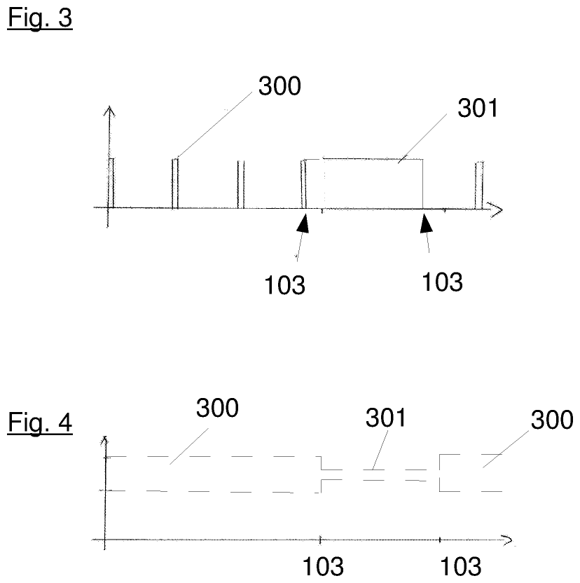

FIG. 3 shows examples of how the fill level gauge measures in the various operating modes. In a first operating mode 300, which is activated as long as the fill level in the rain overflow basin 100 is below a previously specified value 103, the continuously measuring fill level sensor 200 shows a reduced measurement rate and measurement accuracy and is only briefly activated for taking measurements and, as soon as the fill level has been determined and sent to the control unit, the sensor is deactivated again and/or switched into a sleep mode. In a second operating mode 301, which is activated as soon as the fill level exceeds the specified value, the fill level gauge is permanently operated and determines the fill level values at least clearly in shorter intervals in comparison to the first operating mode 300.

Due to the lower requirements for the measuring accuracy, a “more inaccurate” measured value 400 can be determined in the first operating mode 300, i.e., a measurement uncertainty may be given by which the measured value fluctuates, which can be greater than in the second operating mode 301.

As soon as the pre-defined fill level 103 is exceeded, the fill level gauge changes into the second operating mode 301. Here, it measures continuously or (depending on the application) with a significantly higher update rate. Since a full rain overflow basin 100 represents a critical case (flooding), the requirements for the measured value with regard to measurement rate and measurement accuracy are significantly higher. For example, in the first operating mode 300, the measurement accuracy may be ±10 cm, and in the second operating mode 301 it may be ±2 mm. The measurement rate is also different, for example the measurement rate in the first operating mode 300 is 0.1-1 measurements per minute, and in the second operating mode 301 it is 2 measurements per second.

As soon as the predefined fill level 103 is fallen short again, the fill level gauge switches back to the first operating mode 300 in order to use as little energy as possible.

FIG. 4 shows the measurement accuracy of the fill level gauge depending on operating mode. The fluctuation width of the determined fill level is shown in each case. In the first operating mode 300, the fluctuation width or in other words the measurement uncertainty is significantly greater than in the second operating mode 301.

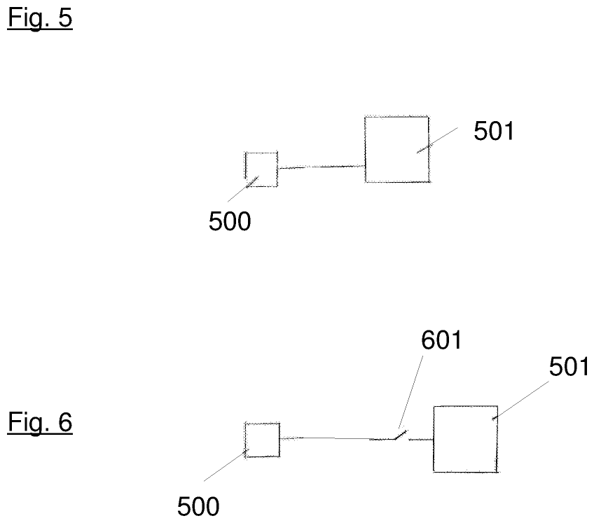

FIG. 5 shows an embodiment of the fill level gauge 200 with a first processor 500, which is very energy efficient, and a second processor 501, which takes over the measurement function in the second operating mode 301. The first processor 500 can put the second processor into an energy saving mode and wake it up again, so that the second processor only needs energy in the second state.

The energy saving mode can also be so pronounced that, as shown in FIG. 6, the first processor 500 completely switches off the second processor 501 by means of a switching device 601 and separates it from a power supply.

### LIST OF REFERENCE NUMBERS

100 rain overflow basin
101 continuously measuring sensor
102 limit sensor
103 pre-defined fill level
104 switching unit
200 fill level sensor
203 electronic measuring system
204 battery
300 first operating mode
301 second operating mode
400 measured value
500 first processor
501 second processor
601 switching device

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. Fill level gauge with a single continuously measured fill level sensor (200) and at least one processor (500) for controlling the fill level sensor (200) and for evaluating the measurements, characterized in that the fill level gauge has at least a first operating mode (300) and a second operating mode (301) for determining the fill level, with the measuring device showing in the first operating mode (300) a first measuring rate and a first measuring precision and showing in the second operating mode (301) a second measuring rate and a second measuring accuracy, wherein the first measurement rate is lower than the second measurement rate and/or the first measurement accuracy is lower than the second measurement accuracy.

2. Fill level gauge according to claim 1, characterized in that the measuring device has a first processor (500) and a second processor (501), wherein the first processor (500) has a lower energy consumption than the second processor (501) and in the first operating mode (300) the first processor (500) is activated and in the second operating mode (301) at least the second processor (501) is activated.

3. Fill level gauge according to claim 2, characterized in that the second processor (501) is deactivated in the first operating mode (300).

4. Fill level gauge according to claim 3, characterized in that the second processor (501) can be activated by the first processor (500).

5. Fill level gauge according to claim 1, characterized in that the fill level gauge has a processor (500, 501) with at least two operating states (300, 301), with the processor (500, 501) in the first operating state (300) showing a lower energy consumption than in the second operating state (301), and the processor (500, 501) in the first operating mode (300) being in the first operating state and in the second operating mode (301) it is in the second operating state.

6. Fill level gauge according to any of the preceding claims, characterized in that a change from the first operating mode (300) into the second operating mode (301) occurs when a predetermined first fill level (103) is fallen short and/or a predetermined second fill level (103) is exceeded and a change occurs from the second operating mode (301) into the first operating mode (300) when the predetermined first fill level (103) is exceeded and/or the predetermined second fill level (103) is fallen short.

7. Fill level gauge according to claim 6, characterized in that the change takes place in consideration of a hysteresis.

8. Fill level gauge according to any of the preceding claims, characterized in that a fill level measurement in the first operating mode (300) is carried out cyclically, especially in 1 to 5 minute increments.

9. Fill level gauge according to any of the preceding procedures (sic), characterized in that the fill level gauge is designed as a radar fill level gauge.

10. Fill level gauge according to any of the preceding claims, characterized in that the fill level gauge is designed as a single-use device with a battery installed in particular fixed in the device.

11. Method for operating a fill level gauge with a single continuously measured fill level sensor (200) and at least one processor (500, 501) for controlling the fill level sensor (200) and for evaluating the measurements, characterized in that the fill level gauge comprises at least a first operating mode (300) and a second operating mode (301) for determining the fill level, with the measuring device in the first operating mode (300) operating with a first measuring rate and a first measuring accuracy and in the second operating mode (301) with a second measuring rate and a second measuring accuracy, wherein the first measurement rate is lower than the second measurement rate and/or the first measurement accuracy is lower than the second measurement accuracy.

12. Method according to claim 11, characterized in that the fill level gauge has at least one first processor (500) and a second processor (501), wherein the first processor (500) shows lower energy consumption than the second processor (501), and in the first operating mode (300) the first processor (500) is activated and in the second operating mode (301) at least the second processor (501) is activated.

13. Method according to any of claim 11 or 12, characterized in that the second operating mode (301) is activated when a first defined fill level (103) is fallen short and/or when a second defined fill level (103) is exceeded.

14. Method according to claim 13, characterized in that the first operating mode (300) is activated when the first fill level is exceeded and/or when the second fill level is fallen short.

15. Method according to claim 14, characterized in that the first operating mode (300) is activated with a hysteresis when the first fill level is exceeded and/or when the second fill level is fallen short.

16. Method according to any of claims 11 to 15, characterized in that the fill level gauge is deactivated in the first operating mode (300) after each measurement for a predetermined period of time or switched into a sleep mode.
